(19) United States
(12) Patent Application Publication
(10) Pub. No.: US 2010/0087173 A1
(43) Pub. Date: Apr. 8, 2010

(54) Inter-threading Indications of Different Types of Communication

(75) Inventors: Hsuan-Yu Jerry Lin, Seattle, WA (US); Kenneth Q. Sabotta, Seattle, WA (US); David T. Pan, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/244,545

(22) Filed: Oct. 2, 2008

(51) Int. Cl. H04W 4/00

(52) U.S. Cl. 455/412.2

(57) ABSTRACT

Different phones are identified as being part of different groups, and indications of communications with the different phones are displayed on a particular phone by group. The indications of communications of different types are displayed inter-threaded chronologically. These communications with the different phones can include communications received from the different phones and communications sent to the different phones.

### BACKGROUND

Current wireless phones oftentimes support different types of communications, such as both voice calls and text messages. These different types of communications are supported with different user interfaces, such as one log of received voice calls that can be displayed to the user and another log of received text messages that can be displayed to the user. This can be problematic on the part of the user as situations can occur where it is difficult for the user to know what they are being told. For example, a user may receive a text message saying to meet at a first restaurant, but plans may change and the user receives a voice call for which a voicemail message is left saying to meet at a second restaurant. In such a situation, it can be difficult for the user to know which of the two restaurants is the meeting location. Thus, current interfaces can degrade the user experience of the phone.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a first communication of a first type is received, the first communication having originated with one or more other phones and being associated with a first group of users. A second communication of a second type is also received, the second communication having originated with the one or more other phones. The second communication is also associated with the first group of users, but the second type is different than the first type. Both an indication of the first communication and an indication of the second communication are concurrently displayed on a screen of the phone, with the indications being inter-threaded chronologically by group.

In accordance with one or more aspects, different phones are identified as being part of different groups. Indications of communications with the different phones are displayed by group. The indications of communications of different types are also displayed inter-threaded chronologically. These communications with the different phones include communications received from the different phones and communications sent to the different phones.

### BRIEF DESCRIPTION OF THE DRAWINGS

The same numbers are used throughout the drawings to reference like features.

FIG. 1 illustrates an example system implementing the inter-threading indications of different types of communication in accordance with one or more embodiments.

FIG. 2 illustrates an example display of indications of inter-threaded communications in accordance with one or more embodiments.

FIG. 3 illustrates an example display allowing a response to an inter-threaded communication to be input by a user in accordance with one or more embodiments.

FIG. 4 is a flowchart illustrating an example process for implementing the inter-threading indications of different types of communication in accordance with one or more embodiments.

FIG. 5 illustrates an example device that can be configured to implement the inter-threading indications of different types of communication in accordance with one or more embodiments.

### DETAILED DESCRIPTION

Inter-threading indications of different types of communication is discussed herein. A phone can receive communications of a variety of different types from one or more other phones. These different types include, for example, text and other messages as well as voice calls. Indications of these different types of received communications are displayed on a screen of the phone concurrently, being inter-threaded chronologically. Indications of responses to any communications by the user of the phone can also be displayed inter-threaded with the other indications chronologically.

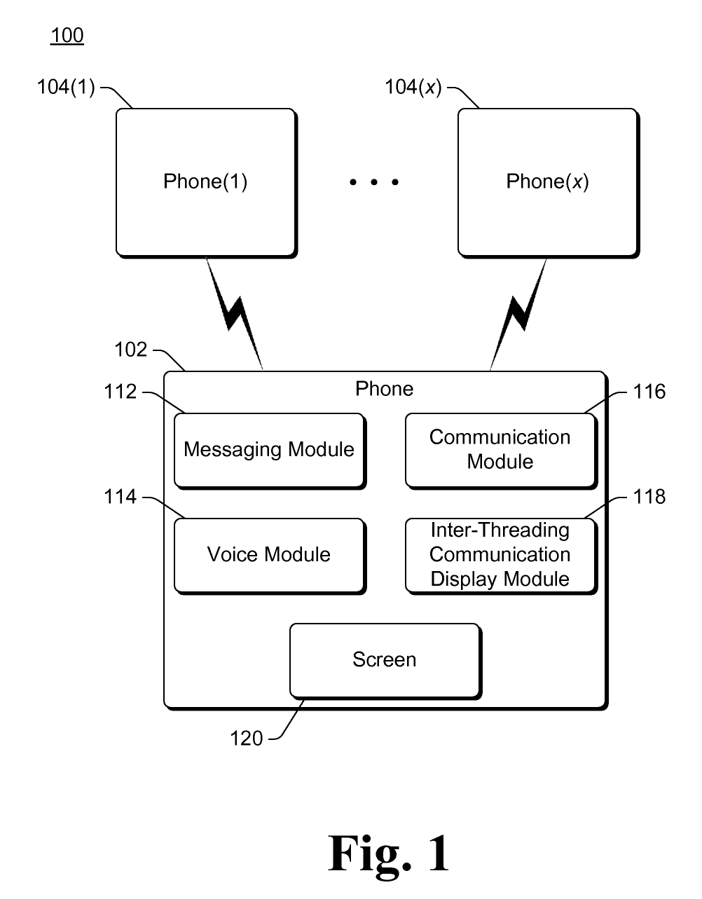

FIG. 1 illustrates an example system 100 implementing the inter-threading indications of different types of communication in accordance with one or more embodiments. System 100 includes a phone 102 that can communicate with one or more (x) other phones 104(1), . . . , 104(x). A phone refers to a communication device capable of sending and receiving phone calls. Such a communication device is also typically capable of sending and/or receiving other types of communication, as discussed in more detail below. Phones 102 and 104 can be a variety of different types of phones, such as cellular phones, satellite phones, other types of wireless phones, handheld computers, personal digital assistants (PDAs), audio and/or video playback devices, and so forth. It is to be appreciated that phones 102 and 104 can include functionality in addition to being able to send and receive phone calls, such as calendar functionality, audio and/or video playback functionality, and so forth. Phones 102 and 104 are typically, but need not be, wireless phones. Different phones 102 and 104 can be the same or different types of phones.

Phones 102 and 104 can communicate with one another using a variety of different technologies and protocols, such as cellular, satellite, and/or other technologies or protocols. Communications among phones 102 and 104 can be via a variety of different networks, such as a public or proprietary telephone network, the Internet, a local area network (LAN), combinations thereof, and so forth.

A variety of different types of communications are supported by phones 102 and 104. These different types of communications can include, for example, text messages, messages with other media, voicemail messages, voice calls, and so forth, as discussed in more detail below. Although the inter-threading indications of different types of communication is discussed herein primarily with reference to text and other media messages, voicemail messages, and voice calls, it is to be appreciated that other types of communications among phones 102 and 104 can also be supported, such as mobile instant messaging, email messages, and so forth.

One type of communication supported by phone 102 is a message, referring to text messages or messages with other types of media such as images, video, audio, combinations of types of media, and so forth. In one or more embodiments, messages comply with the Short Message Service (SMS) communication protocol. In one or more other embodiments, messages comply with the Multimedia Messaging Service (MMS) communication protocol. It is to be appreciated that SMS and MMS are only example protocols, and that other communication protocols can alternatively be used. An identifier of the phone originating the message is also received as part of the message. In one or more embodiments, this identifier of the originating phone is a phone number of the originating phone.

Another type of communication supported by phone 102 is a voicemail message. Voicemail messages can be transcribed and the resulting text from the voicemail message displayed on phone 102. This transcription can be performed by a remote service, such as another device in communication with the phone. This transcription can be done automatically (e.g., using software, firmware, hardware, or combinations thereof), or alternatively can be done manually by a human. Alternatively, the voicemail message can be communicated to phone 102 and the transcription can be performed by phone 102 itself. The voicemail message is a result of a voice call originated by a phone 104, and an identifier of the originating phone is maintained with the voicemail message. This can be passed to the phone along with or as part of the voicemail message (whether transcribed or not transcribed). In one or more embodiments, this identifier of the originating phone is a phone number of the originating phone.

A transcribed voicemail message can be communicated from a remote transcribing service in a variety of different manners. For example, the transcribed voicemail message can be sent as a text message or other type of message.

Another type of communication is a voice call. This can include voice calls that are answered by the user of the phone, as well as voice calls that are not answered by the user of the phone, voice calls that are explicitly ignored by the user, and so forth. This can also include voice calls for which a voicemail message was left (whether transcribed or not), and voice calls for which no voicemail message was left.

Various other types of communications can also be supported by the inter-threading indications of different types of communication. Examples of such types of communications include mobile instant messaging, email, and so forth. In one or more embodiments an identifier of the source of a communication is received along with the communication. Alternatively, an identifier of the source can be obtained in other manners. For example, an email message may be received with an identifier of an email address of a device originating the email message. This email address can be compared to a contact list (e.g., maintained by phone 102), and another identifier of the originating device (e.g., a telephone number associated with a same user as the email address is associated with) can be identified.

Communications of these various types that are received at phone 102 originate with another phone 104. The originating phone has an associated identifier, which is typically a phone number assigned to the originating phone but alternatively can be another identifier. The user of the phone originating the communication can also be referred to as the originator of the communication. The communications can pass through other components, devices, and/or services, but are still viewed as originating with the other phone 104. Analogously, phone 102 (or user of phone 102) can be the originator of communications of these various types that are sent to other phones 104.

Communications originating with another phone 104 and sent to phone 102 can also be referred to as targeting phone 102 and/or the user of phone 102. Similarly, communications originating with phone 102 and sent to another phone 104 can also be referred to as targeting the other phone 104 and/or the user of the other phone 104.

Phone 102 includes a messaging module 112, a voice module 114, a communication module 116, an inter-threading communication display module 118, and a screen 120. Communication module 116 manages receiving of communications from and sending of communications to phones 104. Messaging module 112 manages text and/or other media messages sent and/or received by communication module 116. Module 112 maintains a list or record of messages sent and/or received by phone 102. Voice module 114 manages voice calls (and optionally voicemail messages) on phone 102. Module 114 maintains a list or record of voice calls made and/or received by phone 102, and optionally maintains a list or record of transcribed voicemail messages received by phone 102.

Inter-threading communication display module 118 manages the display of different types of communication inter-threaded chronologically, as discussed in more detail below. The different types of communication are displayed on screen 120. Screen 120 can be any of a variety of screens via which indications of the various communications are displayed.

Inter-threading communication display module 118 obtains indications of different communication types from the modules in phone 102 that manage those communications. For example, module 118 can obtain indications of voice calls and transcribed voicemail messages from voice module 114. By way of another example, module 118 can obtain indications of text messages and other media messages from messaging module 112. Alternatively, module 118 can obtain indications of different communications from communication module 116.

Indications of the various communications received by and/or sent by phone 102 can be displayed to the user of phone 102 on screen 120. These indications can include simply an indication that the communication was received or sent, such as text or another indicator that a voice call from a particular phone number was received, text or another indicator that a phone call to a particular phone number was made, and so forth. These indications can also include the actual communication, such as the content of a text message, the transcribed content of a voicemail message, and so forth. These indications and their display are discussed in more detail below.

Communications received by and sent by phone 102 are categorized into different groups. The user of phone 102 can identify different individuals (or phones) that he or she desires to include in each particular group. This identification can be performed in a variety of different manners. For example, the user could select individuals from a contacts list or an address book and assign them to different groups. By way of another example, when a communication is received from another phone 104 the user of phone 102 could identify a particular group to which the user originating the communication is to be assigned. By way of yet another example, a user of phone 102 can receive an indication of a particular group and individuals in that group from another device, such as another phone 104, a remote server device, and so forth.

In one or more embodiments, each group has an associated group identifier. The group identifier is used to assign communications to a particular group. In one or more embodiments, the group identifier is a value generated based on the phone numbers of the phones of all the users in the group (including, or alternatively excluding, the phone number of phone 102). This value can be generated in a variety of different manners, such as by concatenating the phone numbers of all the users in the group, using any of a variety of well-known hash algorithms to generate a hash value based on the phone numbers of the users in the group, and so forth.

When a communication is received at phone 102 from another phone 104, a group identifier for the communication is determined so that the communication can be associated with the proper group. The communication includes a phone number of the originator of the communication as well as a phone number of each target of the communication. These phone numbers are used to determine the group identifier for the communication.

Similarly, when a communication is received from a user of phone 102 to be sent to one or more other phones 104, a group identifier for the communication is determined so that the communication can be associated with the proper group. The communication includes a phone number of each target of the communication. This (or these) phone number is used, optionally with the phone number of phone 102, to determine the group identifier for the communication.

As an example, the group identifier can be generated as follows, based on the phone numbers of the user phones of the users in the group. Each phone number is normalized so that different representations of the phone number reduce to the same string. For example, one representation of a phone number may include the area code in parentheses, another representation of the same phone number may have no parentheses but may have a hyphen after the area code, and so forth. This normalization can be performed in different manners, such as by having a predetermined representation for the phone numbers and converting each phone number to this predetermined representation (e.g., adding and/or removing parentheses as needed, adding and/or removing hyphens as needed, adding and/or removing area codes as needed, and so forth).

A group identifier having a fixed size is then generated using the normalized phone numbers. The group identifier can be, for example, a 128-bit value, although alternatively larger or smaller sizes can be used. The group identifier is generated using one of two different techniques. A first technique is used for situations where there is only one target and one source (e.g., phone 102 and one other phone 104). The normalized phone number of the other phone (a phone 104) is used as the group identifier. A second technique is used for situations where there are three or more phone numbers in the group (e.g., two or more phones 104). Using the second technique, the normalized phone numbers in the group are sorted. This sorting can be performed in a variety of different manners, such as in ascending or descending numerical order, in alphabetical order, or according to some other criteria or algorithm. The normalized phone number for phone 102 can be excluded from this sorted list, or alternatively can be included in this sorted list. The sorted normalized phone numbers are concatenated in accordance with their sorted order to generate a sorted normalized phone number string. A hash function is then applied to the sorted normalized phone number string to generate a hash value that is used as the group identifier. A variety of different hash functions can be used, including both cryptographic or one-way hash functions, non-cryptographic hash functions, and so forth. Examples of such hash functions include the MD5 (Message-Digest algorithm 5) hash function, the SHA-1 (Secure Hash Algorithm 1) hash function, and so forth.

In one or more embodiments the group identifier includes the phone number of phone 102. Alternatively, the phone number of phone 102 can be excluded from the group identifier. Excluding the phone number from the group identifier can allow the user to change phone numbers for his or her phone without altering his or her groups. Such a change in phone numbers could occur, for example, by a user changing a Subscriber Identity Module (SIM) card used in his or her phone. As the phone number of phone 102 is excluded from the group identifier, the user's groups remain the same despite the change in phone number.

Alternatively, communications can be assigned to groups in other manners without using a group identifier. For example, the user of phone 102 could generate multiple groups each having one or more other individuals. A record of these multiple groups can be maintained, such as a separate “groups” list, or an indication of one or more groups to which an individual belongs could be maintained with each individual in a contact list or address book. When a communication is received at phone 102, the record can be checked to determine which one or more groups the originator of the communication belongs to. Similarly, when a communication is sent by phone 102, the record can be checked to determine which one or more groups the individual to which the communication is being sent belongs.

Indications of communications from and/or to the individuals in a particular group are displayed together on screen 120. The indications of the communications are inter-threaded chronologically so that indications of communications received (or sent) before other communications are displayed earlier than the indications of the other communications. Displaying the indications earlier can be implemented in different manners, such as displaying the communications above other communications, to the left of other communications, and so forth. In one or more embodiments, the date and/or time that a communication was received (or sent) is also displayed as part of (or along with) the indication of the communication.

In one or more embodiments, the time for a particular communication is assigned based on the time the communication is received (or sent) by phone 102. Alternatively, other times can be used. For example, in situations where transcription of a voicemail message is performed by a remote service, the time assigned to a voicemail message can be the time that the voicemail message is received by the remote service. This time can then be communicated to phone 102 along with the transcribed voicemail message.

The indications of communications are displayed inter-threaded chronologically regardless of the types of the communications. Text messages, MMS messages, transcribed voicemail messages, indications of received voice calls, indications of voice calls initiated by the user of phone 102, and so forth are displayed on screen 120 inter-threaded chronologically. In one or more embodiments indications of different types of communications are displayed differently on screen 120, such as using different fonts, different colors, different backgrounds, and so forth to help distinguish different types of communications. The manner in which indications of different types of communications are displayed can optionally be set by a user of phone 102.

The communications are also displayed on screen 120 by group. Communications associated with different groups are displayed at different times on screen 120. Alternatively, communications associated with multiple groups can be displayed concurrently in different portions of screen 120. The particular group's communications that are displayed at a particular time can be determined in a variety of different manners. For example, the user could select a particular group from a group listing, in response to which module 118 displays the communications from the selected group. By way of another example, the user could select a particular person from a contact list or address book, in response to which module 118 displays the communications from the group with which the selected user is associated. By way of yet another example, module 118 can display the communications from the group with which the originator of the most recently received communication is associated.

Additionally, it should be noted that one or more indications of communications can also include a date and/or time (also referred to as a timestamp) that the communications was received and/or sent. Indications of communications for some types can include such dates and/or times whereas others do not. For example, SMS or MMS message indications may include times whereas indications of other communication types do not include times. Alternatively, the order in which indications are displayed can be used to inherently identify the order in which communications were received without displaying dates and/or times for the indications.

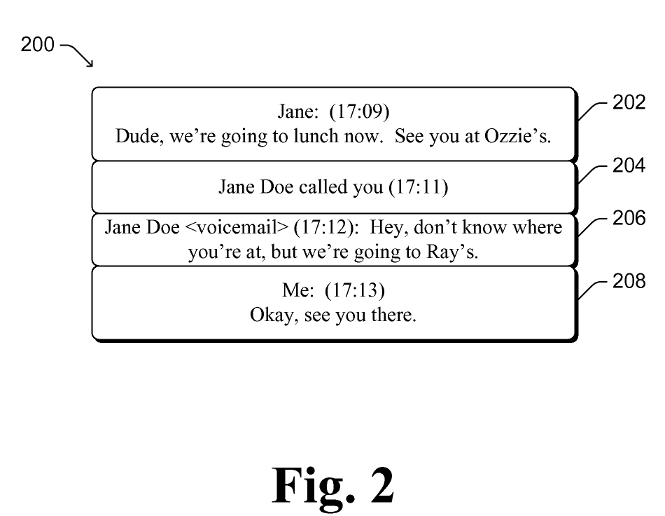

FIG. 2 illustrates an example display of indications of inter-threaded communications in accordance with one or more embodiments. In the example of FIG. 2, indications of communications sent or received earlier chronologically are displayed in an inter-threaded communication list 200 above indications of subsequently sent or received communications. Indications of communications are displayed on a screen, such as screen 120 of FIG. 1.

Indications of four different communications for one group are displayed in FIG. 2. A first indication 202 is a text message from a user Jane saying where to meet for lunch. The indication 202 also includes a time (17:09) that the communication was received. A second indication 204 is a voice call indication, identifying that a user Jane Doe has called. The indication 204 also includes a time (17:11) that the communication was received. A third indication 206 is a transcribed voicemail message from a user Jane Doe, indicating a different meeting place for lunch. The indication 206 also includes a time (17:12) that the communication was received. A fourth indication 208 is a text message sent by the user of the device on which the indications are being displayed. The fourth indication 208 also includes a time (17:13) that the communications was received.

As shown in FIG. 2, the indications of the messages, voice calls, and transcribed voicemail messages are displayed inter-threaded chronologically. Some indications include the content of the communication (e.g., indication 202 includes the content of the text message), whereas other indications do not include the content of the communication (e.g., indication 204 is a text indicator that a user Jane Doe has called, but does not include the content of the voice call).

This display illustrated in FIG. 2 allows the user to easily identify the chronological order of communications regardless of the source of the communications. As can be seen in FIG. 2, the user can easily see that the correct meeting place for lunch is Ray's, as the communication stating that Ray's is the meeting place occurs chronologically after the communication stating that Ozzie's is the meeting place. Without the inter-threaded display shown in FIG. 2, it would be difficult for the user to ascertain the correct meeting place for lunch, as it would be difficult for the user to determine which came first: the text message to meet at Ozzie's or the voicemail message to meet at Ray's.

Also shown in FIG. 2 is the message response to a voicemail message. The indication 206 is a transcribed voicemail message having been left as a result of a voice call. However, as the indication 206 is displayed as part of inter-threaded communication list 200, the user can readily send a response using a message (e.g., text message, MMS message, and so forth).

In the example of FIG. 2, the indications are displayed with timestamps indicating the times that the communications were received. In alternate embodiments, such timestamps are not displayed. Rather, the order of the display of the indications inherently identifies the chronological order in which the communications were received.

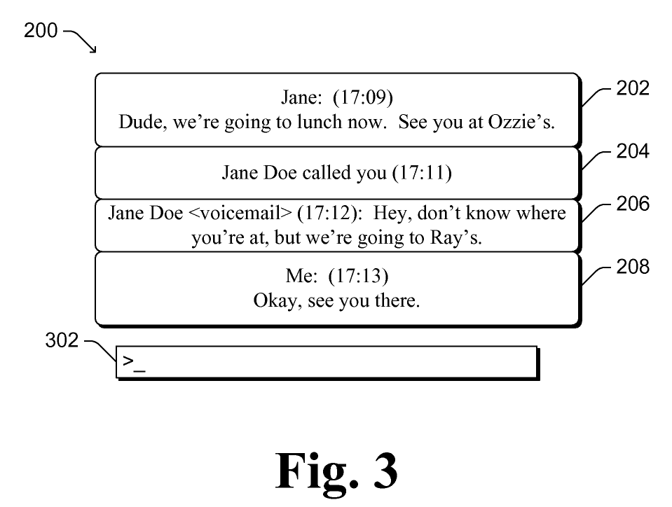

Additionally, the phone displaying the indications of inter-threaded communications allows the user to input text and/or other media for sending to other phones. FIG. 3 illustrates an example display allowing a response to an inter-threaded communication to be input by a user in accordance with one or more embodiments. FIG. 3 illustrates inter-threaded communication list 200 as discussed with reference to FIG. 2.

Additionally, in FIG. 3 a text entry field 302 is shown that allows the user to input text to be sent to other phones. The text that is entered into field 302 is sent to one or more other phones that are part of the group for which indications of communications are being displayed in list 200. The text can be entered in a variety of different manners, such as using a touchpad, keypad, verbal inputs, and so forth. A “send” or “transmit” functionality can also be invoked in order to send the text that was entered to the other phones. Although illustrated as a text entry field, it is to be appreciated that other types of media can alternatively be input using field 302 and/or other input fields.

As can be seen from the examples in FIGS. 2 and 3, the displaying of the indications of the inter-threaded communications allows the user to easily view a history of communications with another user (or group of users). This history is displayed chronologically, with indications of different types of communication being displayed inter-threaded. Both incoming communications (communications received from another user) and outgoing communications (communication sent to another user or group of users) can be displayed, allowing a more robust history to be displayed to the user.

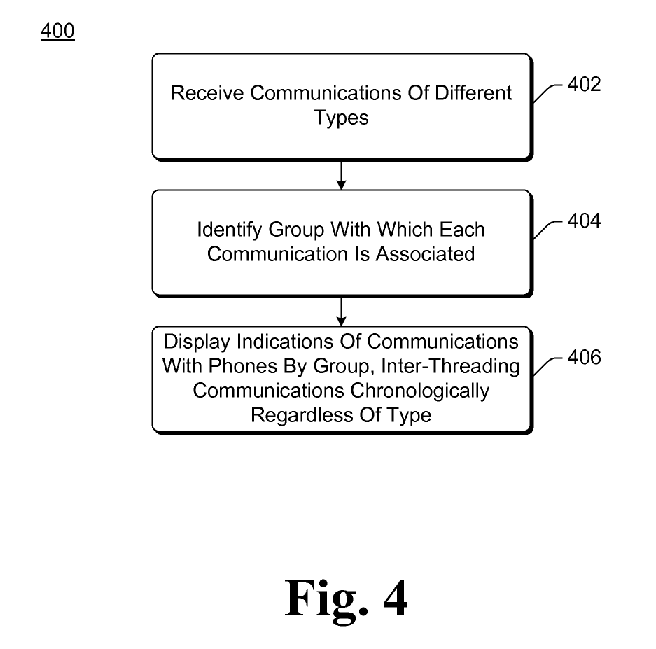

FIG. 4 is a flowchart illustrating an example process 400 for implementing the inter-threading indications of different types of communication in accordance with one or more embodiments. Process 400 is carried out by a phone, such as a phone 102 of FIG. 1, and can be implemented in software, firmware, hardware, or combinations thereof. Process 400 is an example process for inter-threading indications of different types of communication; additional discussions of inter-threading indications of different types of communication are included herein with reference to different figures.

In process 400, communications of different types are received (act 402). As discussed above, a variety of different types of communications can be received in act 402. This receiving can include receiving communications from other phones, as well as receiving communications from a user of the phone implementing process 400.

For each communication received, a group with which the communication is associated is identified (act 404). The communication is associated with the group with which the originator of the communication is associated, as discussed above. As discussed above, the group with which the originator of a communication is associated can be identified in a variety of different manners, and typically is based at least in part on an identifier of the originator of the communication. Similarly, for communications received from a user of the phone implementing process 400 (and that are to be sent by the phone implementing process 400), the communication is associated with the group with which the one or more targets of the communication are associated, as discussed above.

Indications of the received communications are then displayed (act 406). The communications are displayed by group, with indications of different types of communications being inter-threaded chronologically regardless of type as discussed above.

Indications of communications associated with different groups can be displayed in act 406 at different times. For example, the user can input a request for communications regarding a particular group to be displayed, such as by selecting an identifier of that particular group from a listing of groups. Alternatively, the particular group displayed at a particular moment can be determined automatically. For example, the group with which the most recently received communication is associated can be the group that is displayed.

Additionally, it should be noted that due to the size of the screen on which the indications are displayed in act 406 (e.g., the size of screen 120 of FIG. 1), situations can arise where too many communications are associated with a group to be displayed concurrently. In such situations, the user is able to scroll through the indications using various inputs, such as up and/or down arrows, a pointer device, verbal inputs, and so forth. Accordingly, in such situations a subset of the communications associated with a group are displayed at any given time.

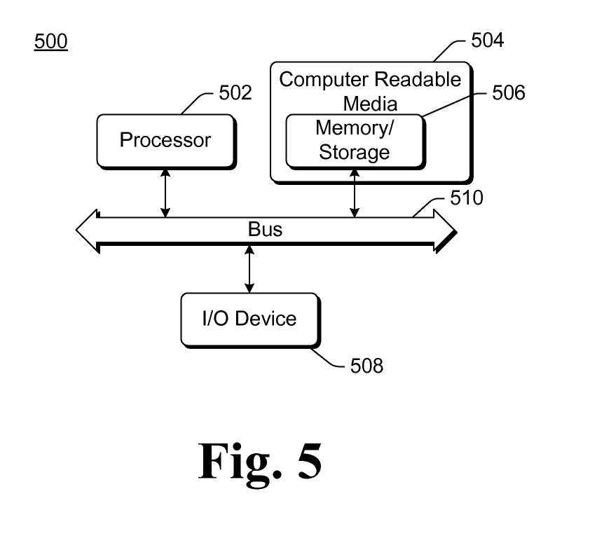

FIG. 5 illustrates an example device 500 that can be configured to implement the inter-threading indications of different types of communication in accordance with one or more embodiments. Device 500 can be, for example, a phone 102 or 104 of FIG. 1.

Device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or one or more I/O devices 508 can be included as part of, or alternatively may be coupled to, device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of device 500, such as in a processing unit 502, in various cache memories of a processing unit 502, in other cache memories of device 500 (not shown), on other computer readable media, and so forth. Additionally, it is to be appreciated that the location where instructions are stored in device 500 can change over time.

One or more input/output devices 508 allow a user to enter commands and information to device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The term module as used herein generally represents software, firmware, hardware, or combinations thereof In the case of a software implementation, the module represents program code that performs specified tasks when executed on a processor (e.g., CPU or CPUs). The program code can be stored in one or more computer readable memory devices, further description of which may be found with reference to FIG. 5. The features of the inter-threading indications of different types of communication techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a phone, the method comprising:
receiving a first communication of a first type, the first communication having originated with one or more other phones and being associated with a first group of users;
receiving a second communication of a second type, the second communication having originated with the one or more other phones, the second communication being associated with the first group of users but the second type being different than the first type; and
concurrently displaying, on a screen of the phone, both an indication of the first communication and an indication of the second communication, inter-threading the indications chronologically by group.

2. A method as recited in claim 1, further comprising:
receiving a third communication of a third type, the third communication having originated with the one or more other phones and being associated with the first group of users, the third type being different than the first type and the second type; and
wherein the displaying comprises displaying the indication of the first communication, the indication of the second communication, and an indication of a third communication, inter-threading the three communications chronologically.

3. A method as recited in claim 1, further comprising:
allowing a user of the phone to scroll through multiple additional indications of communications having originated with the one or more other phones.

4. A method as recited in claim 1, further comprising:
displaying, with the indication of the first communication and the indication of the second communication, an indication of a third communication sent from the phone to the one or more other phones, inter-threading the first communication, the second communication, and the third communication chronologically.

5. A method as recited in claim 1, the first communication being a transcribed voicemail message, the method further comprising:
receiving, from a user of the phone, a message; and
sending, to the one or more other phones, the message in response to the transcribed voicemail message.

6. A method as recited in claim 1, the first type comprising a text message or other media message, and the second type comprising a phone call or a transcribed voicemail message.

7. A method as recited in claim 1, the indication of the first communication comprising the first communication, and the indication of the second communication comprising a text indicator that the second communication was received.

8. One or more computer storage media having stored thereon multiple instructions that, when executed by one or more processors of a phone, cause the one or more processors to:
identify different phones as being part of different groups; and
display indications of communications with the different phones by group, inter-threading indications of communications of different types chronologically, the communications with the different phones including communications received from the different phones and communications sent to the different phones.

9. One or more computer storage media as recited in claim 8, wherein to identify the different phones as being part of different groups is to identify the different phones as being part of different groups based at least in part on phone numbers of the different phones.

10. One or more computer storage media as recited in claim 9, wherein the instructions further cause the one or more processors to generate an identifier for each of the different groups, the identifier for each group being a hash value based on the phone numbers of phones in the group.

11. One or more computer storage media as recited in claim 8, the communications of different types comprising voice calls received by the phone, messages received by the phone, and messages sent by the phone.

12. One or more computer storage media as recited in claim 8, the instructions further causing the one or more processors to:
receive a transcribed voicemail message;
display the transcribed voicemail message as part of the indications of communications;
receive, from a user of the phone, a message; and
send, to one of the different phones that originated the transcribed voicemail message, the message in response to the transcribed voicemail message.

13. One or more computer storage media as recited in claim 8, wherein to display the indications of communications is to display indications of communications associated with a single group concurrently, and display indications of communications associated with different groups at different times.

14. One or more computer storage media as recited in claim 8, each of one or more of the indications of communications including content of the communication.

15. A phone comprising:
a screen; and
an inter-threading communication display module to display indications of communications with different phones, inter-threading indications of communications of different types chronologically by groups of which the different phones are a part, the communications with the phones including communications received from the different phones and communications sent to the different phones.

16. A phone as recited in claim 15, the inter-threading communication display module being further to identify the different phones as being part of different groups based at least in part on phone numbers of the different phones.

17. A phone as recited in claim 15, the communications of different types comprising voice calls received by the phone, messages received by the phone, and messages sent by the phone.

18. A phone as recited in claim 15, the inter-threading communication display module being further to:
display a transcribed voicemail message as part of the indications of communications;
receive, from a user of the phone, a message; and
send, to one of the different phones that originated the transcribed voicemail message, the message in response to the transcribed voicemail message.

19. A phone as recited in claim 15, wherein to display the indications of communications is to display indications of communications associated with a single group concurrently, and display indications of communications associated with different groups at different times.

20. A phone as recited in claim 15, each of one or more of the indications of communications including content of the communication.
